(19) United States
(12) Patent Application Publication
(10) Pub. No.: US 2007/0187379 A1
(43) Pub. Date: Aug. 16, 2007

(54) Weld joint and weld material thereof

(76) Inventors: Takahiro Osuki, Osaka (JP); Kazuhiro Ogawa, Nishinomiya-shi (JP); Yoshitaka Nishiyama, Nishinomiya-shi (JP)

Correspondence Address: CLARK & BRODY, 1090 VERMONT AVENUE, NW, SUITE 250, WASHINGTON, DC, 20005, US

(21) Appl. No.: 11/700,175

(22) Filed: Jan. 31, 2007

Related U.S. Application Data
(63) Continuation of application No. PCT/JP05/13353, filed on Jul. 21, 2005.

(30) Foreign Application Priority Data
Aug. 2, 2004 (JP) 2004-226110

(51) Int. Cl. B23K 9/23

(52) U.S. Cl. 219/137 WM

(57) ABSTRACT

The invention is directed to a weld joint comprising both a base material and a weld metal both having a chemical composition including C: 0.01-0.45%, Si: more than 1%, 4% or less, Mn: 0.01-2%, P: 0.05% or less, S: 0.01% or less, Cr: 15-35%, Ni: 40-78%, Al: 0.005-2%, N: 0.001-0.2% and Cu: 0.015-5.5% in mass percent, further including Ti satisfying the following formula (1), and the balance being Fe and impurities. Both the material and the weld metal may further include one or more kinds of Co, Mo, Ta, W, V, Zr, Nb, Hf, B, Ca, Mg, and REM.
{(Si-0.01)/30}+0.01Cu≦Ti≦5 (1) wherein a symbol of an element in formula (1) means a content of the element (mass percent).

The disclosure of Japan Patent Application No. 2004-226110 filed Aug. 2, 2004 including specification, drawings and claims is incorporated herein by reference in its entirety. This application is a continuation of International Patent Application No. PCT/JP2005/013353, filed Jul. 21, 2005. This PCT application was not in English as published under PCT Article 21(2).

### TECHNICAL FIELD

The present invention relates to weld joints of members used in a corrosive environment at a high temperature and weld materials thereof. As the members used in a corrosive environment at the high temperature, for example, there are listed a container, a reaction tube and components used in a heat exchange type hydrocarbon reformer, a waste heat recovery apparatus and the like in GTL plant of an petroleum refinery and a petroleum chemistry plant etc.

### BACKGROUND ART

Heat exchange has been widely utilized to enhance energy efficiency for waste heat recovery in a reformer in the petroleum refinery and the petroleum chemistry plant etc., and ammonium production and hydrogen production apparatuses from petroleum etc. as raw materials. On the other hand, from now on, significant increase in demand of clean energy such as hydrogen gas and methanol is expected, a reformer which is essential for these productions is required to be a large scale with high thermal efficiency suitable for mass production.

Metal materials for reaction tubes and the like in the above-described apparatuses are generally exposed to reactive gases containing H₂, CO, CO₂, H₂O and hydrocarbon (methane etc.) in the high temperature of about 1000° C. or more. In the temperature region, the surface of metal materials in which elements such as Cr and Si more easily oxidized than Fe, Ni etc. is selectively oxidized to form a dense oxide film. This fact suppresses corrosion of metal materials.

In order to utilize the heat of a high temperature gas effectively, however, of importance is heat exchange in a temperature region of 400 to 700° C. lower than conventional. In this temperature region, carburization occurs in high Cr-high Ni—Fe alloy based metal materials used in reaction tubes and heat exchangers, which poses a corrosion problem associated therewith. The reason for carburization of the metal materials is that the relatively low temperature parts of heat exchanger etc. delay in formation of oxide film that has a suppression effect against corrosion.

When carburized layers containing carbide of Cr, Fe etc. are formed in the metal materials, the parts expand, so that minute cracks tend to be generated. Further, when the formation of carbide in the metal materials is saturated, the carbide is decomposed from the surface of the metal materials to generate metal powder, peeled out and corrosion wear proceeds. This is the principle of metal dusting generation. Metal dust peeled off advances carbon precipitation on the surface of the metal materials. When clogging inside a tube due to such wear and carbon precipitation is enlarged, this could lead to break-down of an apparatus, therefore, the selection of material as a member of apparatus must be considered sufficiently.

Conventionally, as an alloy for such apparatus member, a high Cr-high Ni—Fe alloy has been used up to date. For example, Patent document 1 discloses a weld joint that is specified in a given range of the relationship between the contents of Si, Cu or S and the contents of Nb, Ta, Ti and Zr; and the contents of Ni, Co and Cu, together with a specification of a chemical composition. In Patent document 1, this weld joint is indicated to be excellent in a corrosion resistance under an environment of sulfuric acid and a weld crack resistance.

Patent document 2 discloses a weld joint of a Ni-based heat resistant alloy that is positively contained with Al, and specified in the relationship between the amount of melt in grain boundary and the fixation of grain boundary. In Patent document 2, this weld joint is indicated to be excellent in a carburization resistance and a high-temperature strength.

Patent document 1: Japanese Unexamined Patent Publication No. 2001-107196A

Patent document 2: Japanese Unexamined Patent Publication No. 2002-235136A

### DISCLOSURE OF THE INVENTION

### Problems to be Solved by the Invention

The weld joint disclosed in Patent document 1 is difficult to use in an environment generating metal dusting because of a small content of Si. The weld joint disclosed in Patent document 2 generates weld solidification cracking when a minimum amount of Si necessary for maintaining a metal dusting resistance is added thereto, and it is difficult to secure good weldability.

An object of the present invention is to provide a weld joint with excellent the metal dusting resistance and no weld solidification cracking.

### Means to Solve the Problems

Meal dusting resistance is improved by including Si, Cu and P, but these elements remarkably increase weld solidification cracking susceptibility. Thus, the present inventors have variously studied aiming at suppressing the weld solidification cracking while maintaining the metal dusting resistance.

The weld solidification cracking takes place when distortion derived from a solidification shrinkage or a thermal shrinkage is beyond the deformation capacity of a weld metal in near a final period of weld solidification process, mainly in a stage that a membranous liquid phase exists in a crystal grain boundary. As a method for reducing weld solidification cracking susceptibility, improvement of the deformation capacity of weld metal can be thought, it needs to alter a basic composition system, which acts counter to the object for maintaining metal dust resistance. Therefore, the present inventors have continued studying on the chemical composition that can make melting point depression of liquid phase smaller to complete solidification sooner without changing a basic component system.

The weld solidification cracking is a serious weld defect in a high alloy with a high concentration of Ni and Cr, several methods are known to prevent the defect. For example, these are a method that the content of elements such as P and S moving a liquidus line into a low temperature side is reduced, and a method that by reducing the content of austenite forming elements such as Ni, C, Mn and Co and increasing ferrite forming elements such as Cr, Si and Mo, a ferrite phase is crystallized as primary phase, then an austenite phase is crystallized by a peritectic/eutectic reaction to lead a solidification configuration to a dual phase microstructure of ferrite-austenite.

However, Cr cannot be contained in more than 35% to prevent the lowering of toughness and deterioration of a hot-workability. Also, Ni must be contained in 40% or more to improve the high-temperature strength, the structure stability and the corrosion resistance. Thus, the foregoing method that a solidification configuration is led to a dual phase microstructure cannot be used.

Consequently, the present inventors have obtained a chemical composition capable of achieving both the metal dusting resistance and a weld solidification cracking resistance simultaneously, based on a high Ni-based alloy of which austenite phase crystallizes as a primary crystal to finish solidification by a single phase of austenite.

The weld solidification cracking susceptibility is increased because elements such as Si, Cu and P decrease a temperature of liquidus line remarkably. Also, generally, it is known that the weld solidification cracking susceptibility is increased when Ti is added to a metal material of austenite single phase.

However, as the result of the studies by the present inventors, it has been found that the weld solidification cracking susceptibility can be remarkably lowered if a suitable amount of Ti is contained in relation to the content of Si and Cu. It is thought that a Si-Ti compound crystallizes in a eutectic solidification configuration with an austenite phase from a liquid phase in a weld solidification process, preventing concentration of Si, Cu and P into a liquid phase, so that the liquid phase finishes solidification promptly.

The present invention has been accomplished on the basis of the foregoing founding, the summary is a weld joint of any one shown in the following (a) to (d), and weld material of any one shown in the following (e) to (h).

(a) A weld joint comprising a base material and the weld metal both having a chemical composition including C: 0.01-0.45%, Si: more than 1%, 4% or less, Mn: 0.01-2%, P: 0.05% or less, S: 0.01% or less, Cr: 15-35%, Ni: 40-78%, Al: 0.005-2%, N: 0.001-0.2% and Cu: 0.015-5.5% in mass percent, further including Ti satisfying the following formula (1), and the balance being Fe and impurities:
{(Si-0.01)/30}+0.01Cu≦Ti≦5 (1)
wherein a symbol of an element in formula (1) means a content of the element (mass percent).

(b) The weld joint described in (a), wherein the base material and the weld metal have a chemical composition including at least one kind selected from Co: 0.015-5.5%, Mo: 0.05-10%, Ta: 0.05%-5%, W: 0.05-5%, V: 0.01-1%. Zr: 0.01-1.4%, Nb: 0.01-1.4% and Hf 0.01-1% in mass percent in place of a part of Fe.

(c) The weld joint described in (a) or (b), wherein base material and the weld metal have a chemical composition including at least one kind selected from B: 0.0005-0.3%, Ca: 0.0005-0.02% and Mg: 0.0005-0.02% in mass percent in place of a part of Fe.

(d) The weld joint of any one described in (a) to (c), wherein the base material and the weld metal have a chemical composition including REM: 0.005-0.3% in mass percent in place of a part of Fe.

The above described weld joint of the present invention is suitable as a weld joint for GTL plant. Additionally, GTL stands for an abbreviation of “Gas to Liquid”, namely is a production of petroleum goods from natural gas.

(e) A weld material to produce the weld joint described in (a) by a TIG welding process, having a chemical composition including C: 0.01-0.45%, Si: more than 1%, 4% or less, Mn: 0.01-2%, P: 0.05% or less, S: 0.01% or less, Cr: 15-35%, Ni: 40-78%, Al: 0.005-2%, N: 0.001-0.2% and Cu: 0.015-5.5% in mass percent, further including Ti satisfying the following formula (1), and the balance being Fe and impurities:
{(Si-0.01)/30}+0.01Cu≦Ti≦5 (1)
wherein the symbol of the element in formula (1) means the content of the element (mass percent).

(f) The weld material described in above (e) to produce the weld joint in the above (b) by the TIG welding process, having a chemical composition including at least one kind selected from Co: 0.015-5.5%, Mo: 0.05-10%, Ta: 0.05-5%, W: 0.05-5%, V: 0.01-1%. Zr: 0.01-1.4%, Nb: 0.01-1.4% and Hf: 0.01-1% in mass percent in place of the part of Fe.

(g) The weld material described in above (e) or (f) to produce the weld joint in the above (c) by the TIG welding process, having a chemical composition including at least one kind selected from B: 0.0005-0.3%, Ca: 0.0005-0.02% and Mg: 0.0005-0.02% in mass percent in place of the part of Fe.

(h) The weld material of any one described in the above (e) to (g) to produce the weld joint in the above (d) by the TIG welding process, having a chemical composition including REM: 0.005-0.3% in mass percent in place of the part of Fe.

### Effect of the Invention

The weld joint of the present invention has an excellent metal dusting resistance, so that it can be utilized as tubes of heating furnace, pipes, and tubes of heat exchanger in the petroleum refinery and the petroleum chemistry plant, which can greatly improve a weld workability, durability and safety of apparatus. Also, the weld material of the present invention is most suitable to produce the above weld joint by the TIG welding process.

### BEST MODE FOR CARRYING OUT THE INVENTION

The reason why chemical composition of the base material and the weld metal of a weld joint is specified in the present invention is as follows. Additionally, in the following explanation, the content of each element expressed as “%” means “% by mass”.

C: 0.01-0.45%

C is an element that acts as enhancing strength of base material and weld metal in the weld joint. When the content of C is less than 0.01%, the high-temperature strength becomes insufficient. However, when the content is more than 0.45%, the toughness of the weld joint is lowered. Accordingly, the content of C was determined to be 0.01-0.45%. The content of C is preferably 0.02-0.4%, most preferably 0.04-0.4%.

Si: more than 1%, and 4% or less

Si is an element that acts as deoxidizing operation in a melt production of the metal materials. Si is also an element that acts as significantly improving metal dusting resistance so that oxide film of Si is formed under the layer of oxide film of Cr in the surface of the weld joint to suppress invasion of C into the weld joint and enhance the activity of C in the weld joint as well. These effects are not exhibited in 1% or less. However, when the content exceeds 4%, the hot-workability and weldability of the base material are remarkably lowered. Accordingly, the content of Si was determined to be more than 1%, and 4% or less. The lower limit is preferably 1.2%, further preferably 1.5%.

Additionally, when the content of N exceeds 0.055%, the upper limit of the content of Si is suitably 2% from the points of the weldability and the hot-workability of the base material.

Mn: 0.01-2%

Mn has a suppressing effect to brittleness in hot-work of the base material due to S contained in impurities and is an effective element for deoxidizing in the melt production. It is necessary to contain Mn in 0.01% or more to obtain these effects. However, when the content of Mn exceeds 2%, the activity of C in the weld joint composed of the base material and the weld metal is lowered, which retards the formation of oxide film of Cr and Al in the surface of the weld joint. Thus, invasion of C from atmosphere is advanced to result in generating metal dusting easily. Accordingly, the content of Mn was determined to be 0.01-2%. The content of Mn is preferably 0.05-1.0%, most preferably 0.1-0.8%.

P: 0.05% or less

P is an impurity element mixed in from raw materials in the melt production of the metal materials, causes a lowering of the corrosion resistance, deteriorates the hot-workability and the weldability. Accordingly, it is desirable to reduce the content of P as low as possible, it was determined to be 0.05% or less. The content of P is preferably 0.03% or less, most preferably 0.02% or less.

S: 0.01% or less

S is also an impurity element mixed in from raw materials in the melt production of the metal materials, causes the lowering of the corrosion resistance, deteriorates hot-workability and the weldability. Accordingly, it is desirable to reduce the content of S as low as possible, it was determined to be 0.01% or less. It is preferably 0.007% or less, further preferably 0.002% or less.

Cr: 15-35%

Cr operates to delay the growth of carburized layer by binding with C invaded in the weld joint in a use environment at the high temperature. In this way, the excellent metal dusting resistance is maintained. The effect is exhibited when the content is 15% or more. However, when the content exceeds 35%, the toughness is lowered and the hot-workability is deteriorated, which makes the production of the base material difficult. Accordingly, the content of Cr was determined to be 15-35%. The content of Cr is desirably 18-33%, further desirably 25.2-33%.

Ni: 40-78%

Ni is an element that acts as enhancing the corrosion resistance in coexistence with Cr while maintaining the high-temperature strength and the structure stability. Ni has also an effect of suppressing the generation of metal dusting. These effects are exhibited when the content of Ni is 40% or more, but saturated in more than 78%. Accordingly, the content of Ni was determined to be 40-78%. The content of Ni is preferably 48-78%, further preferably 50-78%. Most preferable is 56-78%.

Al: 0.005-2%

Al is an element that has a deoxidizing operation in the melt production of the metal materials. Al forms oxide film of Al under the layer of oxide film of Cr in the surface of the weld joint or on the outermost surface of the weld joint, suppresses the invasion of C into the metal materials and also enhances the activity of C in the metal materials to operate in improving metal dusting resistance remarkably. The content of Al is required to be 0.005% or more so as to obtain these effects. However, when the content exceeds 2%, the hot-workability and the weldability of the base material are remarkably lowered. Accordingly, the content of Al was determined to be 0.005-2%. The upper limit of the content of Al is further preferably 1.5% or less. It is further preferable that the lower limit of the content of Al is 0.01%, and the upper limit is less than 0.8%.

N: 0.001-0.2%

N is an element that acts as improving the metal dusting resistance by enhancing the activity of C in the base material. The effect is insufficient when the content is less than 0.001%. However, when the content is more than 0.2%, a lot of nitrides of Cr and Al are formed to lower the hot-workability and the weldability remarkably. Accordingly, the content of N was determined to be 0.001-0.2%. It is desirable that the upper limit is less than 0.02%.

Additionally, in the case where Si is 2% or less, it is desirable that the lower limit of the content of N is set in 0.005%. On the other hand, in the case where the content of Si is set in 1.5% or more to enhance the metal dusting resistance greatly, it is preferable that the upper limit of the content of N is set in 0.055% from the points of the weldability and the hot-workability. In this case, the upper limit of the content of N is more preferably 0.035%, most preferably 0.025%.

Cu: 0.015-5.5%

Cu is an element that improves the metal dusting resistance by enhancing the activity of C in the weld joint and suppressing the growth of carburized layer. The effect is exhibited when Cu is contained in 0.015% or more. However, when Cu is contained in more than 5.5%, the toughness of base material and the weld metal is lowered, the hot-workability markedly lowered. The weld solidification cracking susceptibility is also remarkably increased. Accordingly, the content of Cu was determined to be 0.015-5.5%. The content of Cu is preferably 0.04-4.8%, further preferably 1.5-4.2%.

Ti: amount satisfying the following formula (1)
{(Si-0.01)/30}+0.01Cu≦Ti≦5 (1)
wherein the symbol of the element in formula (1) means the content of the element (mass percent).

Ti is a carbide forming element, an element that acts as enhancing the metal dusting resistance by suppressing the growth of carburized layer, and the high-temperature strength. Ti also acts as reducing the weld solidification cracking susceptibility by forming a compound with Si at the high temperature.

To reduce weld solidification cracking susceptibility, the content of Ti is required to be {(Si-0.01)/30}+0.01Cu≦Ti, in relation to the content of Si and Cu. This is because the smaller the content of Si and Cu, the more largely is decreased the content of Ti necessary for reducing the weld solidification cracking susceptibility. When Ti is contained in a range of {(Si-0.01)/30}+0.01Cu≦Ti, an adverse influence of P on the weld solidification cracking can be also suppressed.

However, when the content of Ti exceeds 5%, it induces the crystal growth of Si—Ti compound alone and a crystal configuration of the compound is not a eutectic solidification microstructure with the austenite phase, and adversely increases the weld solidification cracking susceptibility. Moreover, the amount of crystallization of Si—Ti compound is increased, which results in the lowering of the hot-workability. It is desirable that the upper limit of the content of Ti is 4%. As described above, Ti was determined such that it contains the range satisfying the above formula (1).

The base material and the weld metal composing the weld joint of the present invention have the above chemical composition, the remaining parts may be composed of Fe and impurities. Also, to aim at further enhancing the metal dusting resistance, in place of the part of Fe, at least one kind selected from Co: 0.015-5.5%, Mo: 0.05-10%, Ta: 0.05%-5%, W: 0.05-5%, V: 0.01-1%. Zr: 0.01-1.4%, Nb: 0.01-1.4% and Hf: 0.01-1% may be contained. This is based on the following reasons.

Co enhances the activity of C in the metal materials, acts as improving the metal dusting resistance by suppressing the growth of the carburized layer. Also, all of Mo, Ta, W, V, Zr, Nb and Hf are carbide forming elements and act as enhancing metal dusting resistance by suppressing the growth of the carburized layer. These effects become remarkable in the case of Co: 0.015% or more; Mo, Ta and W each 0.05% or more; V, Zr, Nb and Hf each 0.01% or more. However, when the content of these elements is too high, the hot-workability, a productional performance, the toughness and the weldability are adversely affected.

Accordingly, it is desirable that the content in the case of containing one or more kinds selected from these elements is Co: 0.015-5.5%, Mo: 0.05-10%, Ta: 0.05%-5%, W: 0.05-5%, V: 0.01-1%. Zr: 0.01-1.4%, Nb: 0.01-1.4% and Hf: 0.01-1%. The content of each of the elements is more preferably Co: 0.02-4.8%, Mo: 1-10%, Ta and W each: 0.5-5%, Zr and Nb each: 0.01-0.8%, V and Hf each: 0.01-0.6%, further, most preferably each Co: 0.05-4.2%, Mo: 1-8%, Ta and W each: 1-3%, Zr and Nb each: 0.02-0.8%, V: 0.01-0.3% and Hf: 0.02-0.6%.

The base material and the weld metal of the weld joint of the present invention aim improving of the hot-workability and in place of the part of Fe, one or more kinds selected from B: 0.0005-0.3%, Ca: 0.0005-0.02% and Mg: 0.0005-0.02% may be contained.

All of these elements are elements having an enhancing operation for the hot-workability. This effect becomes remarkable in the case of each containing 0.0005% or more. However, when the content of B is more than 0.3%, the weld joint becomes brittle and the melting point is lowered as well, which causes the hot-workability and the weldability to be lowered.

When the content of Ca or Mg is more than 0.02%, it leads to deterioration of surface quality of product resulting from formation of oxide-based inclusion substance, and to the lowering of the corrosion resistance. Accordingly, in the case of containing one or more kinds selected from these elements, the content is preferably B: 0.0005-0.3%, Ca and Mg each: 0.0005-0.02%. It is more desirable that every element is in 0.0005-0.015%, most desirably is in 0.0005-0.012%.

The base material and weld metal of the weld joint according to the present invention aim the improving of the corrosion resistance, REM: 0.005-0.3% may be contained in place of the part of Fe. Additionally, REM is a generic name of total 17 elements of Sc, Y and lanthanoid.

REM acts as enhancing the corrosion resistance by improving adhesion due to enhanced uniformity of oxide film containing Cr and Al generated on the surface of the weld joint in a use environment. The effect is markedly exhibited in the case of 0.005% or more. However, when the content exceeds 0.3%, a coarse oxide is formed, increasing the generation of surface defect as well as causing the lowering of the toughness and the hot-workability. Accordingly, in the case of addition of REM, the content is suitably 0.005-0.3%. The content of REM is more preferably 0.005-0.1%, most preferably 0.005-0.07%.

As described above, components composing the base material and the weld metal have been explained. The base material and the weld metal both have a chemical composition in the same range of content of each component, but this does not necessarily mean that the chemical composition of the base material and the weld metal are completely equal. Each component in the base material and the weld metal is suitably set within the foregoing range of content. For example, C of the base material is given as 0.10%, C of the weld metal may be 0.15%.

The weld joint of the present invention can be produced by various welding methods such as a TIG welding or a MIG welding. The weld materials may be selected from a composition that can obtain the foregoing composition of the weld metal according to a welding method and welding conditions adopted. Also, in the case where the TIG welding is adopted, it is desirable that the materials in the above (e) to (h) are used.

### EXAMPLES

Metal materials whose chemical compositions are shown in Tables 1 and 2 were melt-produced using a high frequency heating vacuum furnace. After ingot of each metal material was forged in an ordinary method, it was subjected to a solid-solution heat treatment at 1200° C., a test piece for constraint weld cracking test of 12 mm thick, 50 mm wide and 150 mm long in which 60° V-groove preparation of a butt part of 1.5 mm was conducted, and a test piece for evaluation of the metal dusting resistance of 4 mm thick, 10 mm wide and 20 mm long were produced.

Using the resultant test piece for constraint weld cracking test, periphery was constraint-welded, using a weld material (weld wire) of 1.2 mm in outer diameter produced from each base material beforehand, a multilayer welding was conducted by the TIG welding under the conditions of weld current of 150 A, weld voltage of 15V and weld speed of 10 cm/min. Here, the chemical composition of the weld metal is the same as that of the base material because of almost no dilution in the case of the TIG welding.

Next, the rate of solidification crack generation in the test piece for constraint weld cracking test to the weld bead length was measured. The results examined are shown both in Tables 1 and 2. Also, using the test piece for evaluation of the metal dusting resistance of each metal material, a test was carried out while maintaining it for 1000 hours at 630° C. in an atmosphere of 26% H₂-60% CO-11.5% CO₂-2.5% H₂O in volume ratio. Thereafter, deposit on the surface of the test piece was removed, followed by ultrasonic cleaning, to examine the existence of pit under an optical microscope. The results are also shown both in Tables 1 and 2. Additionally, a target of the metal dusting resistance is no generation of pit in less than 200 hours.

TABLE 1

| Steel | Chemical composition(mass %) Balance: Fe and impurities | | | | | | | | | | | | | |
|---|---|---|---|---|---|---|---|---|---|---|---|---|---|---|
| No | C | Si | Mn | P | S | Cu | Ni | Cr | Al | Ti | N | Co | Mo | Ta |
| 1 | 0.060 | 1.47 | 0.20 | 0.011 | 0.001 | 1.51 | 56.40 | 30.70 | 0.021 | 0.026* | 0.008 | — | — | — |
| 2 | 0.032 | 1.50 | 0.20 | 0.012 | 0.001 | 2.44 | 56.10 | 30.70 | 0.019 | 0.025* | 0.008 | — | 1.97 | — |
| 3 | 0.310 | 1.51 | 0.20 | 0.011 | 0.001 | 1.52 | 56.70 | 30.20 | 0.021 | 0.025* | 0.008 | — | — | — |
| 4 | 0.030 | 1.48 | 0.20 | 0.002 | 0.001 | 1.53 | 63.18 | 30.69 | 0.029 | 0.026* | 0.008 | — | — | — |
| 5 | 0.030 | 1.03 | 0.20 | 0.002 | 0.001 | 2.94 | 63.17 | 30.85 | 0.019 | 0.024* | 0.008 | — | 1.96 | — |
| 6 | 0.028 | 1.49 | 0.20 | 0.002 | 0.001 | 1.53 | 57.54 | 30.52 | 0.018 | 0.025* | 0.008 | — | 1.97 | — |
| 7 | 0.010 | 1.32 | 0.20 | 0.002 | 0.001 | —* | 66.60 | 30.02 | 0.057 | 0.77 | 0.005 | — | — | — |
| 8 | 0.010 | 1.37 | 0.20 | 0.002 | 0.001 | 1.45 | 65.30 | 29.82 | 0.047 | 1.18 | 0.005 | — | — | — |
| 9 | 0.013 | 1.47 | 0.21 | 0.003 | 0.002 | 1.01 | 61.96 | 30.69 | 0.023 | 1.01 | 0.006 | 0.96 | — | — |
| 10 | 0.013 | 1.43 | 0.20 | 0.003 | 0.001 | 1.95 | 60.26 | 30.17 | 0.024 | 1.19 | 0.005 | — | 1.96 | — |
| 11 | 0.050 | 1.64 | 0.20 | 0.003 | 0.001 | 0.04 | 62.80 | 28.81 | 0.033 | 0.64 | 0.002 | — | — | 4.04 |
| 12 | 0.012 | 1.44 | 0.20 | 0.003 | 0.001 | 1.94 | 56.55 | 29.97 | 0.025 | 1.21 | 0.005 | — | — | — |
| 13 | 0.010 | 1.47 | 0.20 | 0.001 | 0.001 | 1.53 | 65.56 | 29.65 | 0.005 | 0.17 | 0.012 | — | — | — |
| 14 | 0.010 | 1.51 | 0.19 | 0.002 | 0.001 | 1.52 | 64.92 | 30.12 | 0.008 | 0.30 | 0.010 | — | — | — |
| 15 | 0.011 | 1.46 | 0.20 | 0.002 | 0.001 | 1.55 | 64.12 | 30.32 | 0.018 | 0.81 | 0.008 | — | — | — |
| 16 | 0.010 | 1.54 | 0.20 | 0.002 | 0.001 | 1.54 | 64.63 | 30.08 | 0.015 | 0.53 | 0.006 | — | — | — |
| 17 | 0.014 | 1.93 | 0.20 | 0.003 | 0.001 | 0.45 | 60.13 | 30.16 | 0.021 | 1.03 | 0.005 | 1.03 | 1.97 | — |
| 18 | 0.010 | 1.40 | 0.20 | 0.002 | 0.001 | 1.52 | 64.57 | 29.87 | 0.020 | 0.98 | 0.007 | — | — | — |
| 19 | 0.010 | 1.44 | 0.20 | 0.002 | 0.001 | 1.53 | 63.58 | 30.24 | 0.026 | 1.34 | 0.008 | — | — | — |
| 20 | 0.010 | 1.42 | 0.20 | 0.002 | 0.001 | 1.54 | 62.99 | 30.28 | 0.024 | 1.57 | 0.006 | — | — | — |

| | | | | | | | | | | Evaluation | |
|---|---|---|---|---|---|---|---|---|---|---|---|
| Steel | Chemical composition(mass %) Balance: Fe and impurities | | | | | | | | | | Metal dust |
| No | W | V | Zr | Nb | Hf | B | Ca | Mg | REM | Weldability | resistance |
| 1 | — | — | — | — | — | — | — | — | — | X | ◯ |
| 2 | — | — | — | — | — | — | — | — | — | X | ⊚ |
| 3 | — | — | — | — | — | — | 0.0050 | — | — | X | ◯ |
| 4 | — | — | — | — | — | 0.0043 | — | — | — | X | ◯ |
| 5 | — | — | — | — | — | 0.0035 | 0.0012 | — | — | X | ⊚ |
| 6 | — | — | — | — | — | 0.0037 | 0.0012 | — | 0.025 | X | ◯ |
| 7 | — | — | — | — | — | — | — | — | — | ◯ | X |
| 8 | — | — | — | — | — | — | — | — | — | ◯ | Δ |
| 9 | — | — | — | — | — | — | — | — | — | ◯ | Δ |
| 10 | — | — | — | — | — | — | — | — | — | ◯ | ◯ |
| 11 | — | — | — | — | — | — | — | — | — | ◯ | Δ |
| 12 | 3.11 | — | — | — | — | — | — | — | — | ◯ | ◯ |
| 13 | — | 0.23 | — | — | — | — | — | — | — | ◯ | ◯ |
| 14 | — | — | 0.57 | — | — | — | — | — | — | ◯ | ◯ |
| 15 | — | — | — | 0.21 | — | — | — | — | — | ◯ | ◯ |
| 16 | — | — | — | — | 0.031 | — | — | — | — | ◯ | ⊚ |
| 17 | — | — | — | — | — | — | — | — | — | ◯ | ◯ |
| 18 | — | — | — | — | — | 0.0033 | — | — | — | ◯ | ◯ |
| 19 | — | — | — | — | — | — | 0.0009 | — | — | ◯ | Δ |
| 20 | — | — | — | — | — | — | — | 0.0007 | — | ◯ | Δ |

—: The content is an impurity level.
*The chemical composition is out of the range limited by the present invention.

TABLE 2

| Steel | Chemical composition(mass %) Balance: Fe and impurities | | | | | | | | | | | | | |
|---|---|---|---|---|---|---|---|---|---|---|---|---|---|---|
| No | C | Si | Mn | P | S | Cu | Ni | Cr | Al | Ti | N | Co | Mo | Ta |
| 21 | 0.011 | 1.45 | 0.21 | 0.002 | 0.001 | 1.54 | 61.73 | 29.98 | 0.025 | 1.99 | 0.006 | — | 1.95 | — |
| 22 | 0.010 | 1.45 | 0.20 | 0.002 | 0.001 | 1.95 | 61.64 | 30.03 | 0.021 | 0.59 | 0.005 | — | 1.98 | — |
| 23 | 0.010 | 1.45 | 0.20 | 0.002 | 0.001 | 1.53 | 62.47 | 29.53 | 0.022 | 1.22 | 0.006 | — | 1.95 | — |
| 24 | 0.011 | 1.48 | 0.20 | 0.002 | 0.001 | 1.94 | 61.11 | 29.97 | 0.019 | 0.19 | 0.005 | — | — | — |
| 25 | 0.031 | 1.21 | 0.20 | 0.012 | 0.001 | 1.52 | 56.20 | 30.59 | 0.020 | 0.68 | 0.008 | — | 1.96 | — |
| 26 | 0.031 | 1.51 | 0.20 | 0.012 | 0.001 | 1.97 | 56.42 | 30.79 | 0.020 | 0.58 | 0.008 | — | 1.97 | — |
| 27 | 0.010 | 1.49 | 0.20 | 0.001 | 0.001 | 1.97 | 61.05 | 30.02 | 0.021 | 0.38 | 0.005 | — | 1.98 | — |
| 28 | 0.011 | 1.47 | 0.20 | 0.001 | 0.001 | 1.65 | 59.49 | 29.68 | 0.026 | 4.10 | 0.006 | — | 1.96 | — |
| 29 | 0.016 | 1.45 | 0.20 | 0.002 | 0.001 | 1.84 | 56.88 | 30.07 | 0.031 | 6.84* | 0.005 | — | 1.96 | — |
| 30 | 0.091 | 3.76 | 0.20 | 0.002 | 0.001 | 0.02 | 62.28 | 30.02 | 0.025 | 0.78 | 0.005 | — | 1.91 | — |
| 31 | 0.087 | 1.03 | 0.20 | 0.002 | 0.001 | 4.86 | 61.08 | 30.33 | 0.032 | 0.38 | 0.006 | — | 1.96 | — |
| 32 | 0.010 | 1.01 | 0.20 | 0.015 | 0.001 | 1.53 | 62.87 | 29.53 | 0.022 | 1.22 | 0.006 | — | 1.95 | — |
| 33 | 0.031 | 0.91* | 0.75 | 0.002 | 0.001 | —* | 61.04 | 30.02 | 0.022 | 0.60 | 0.008 | — | — | — |
| 34 | 0.057 | 1.34 | 0.20 | 0.002 | 0.001 | 0.30 | 59.12 | 25.63 | 2.050* | 0.04 | 0.010 | — | 2.41 | — |
| 35 | 0.011 | 1.42 | 0.05 | 0.002 | 0.001 | 1.52 | 65.62 | 29.74 | 0.018 | 0.60 | 0.006 | — | — | — |
| 36 | 0.010 | 1.49 | 1.96 | 0.002 | 0.001 | 1.53 | 61.95 | 29.86 | 0.020 | 0.61 | 0.005 | — | 2.88 | — |

| | | | | | | | | | | Evaluation | |
|---|---|---|---|---|---|---|---|---|---|---|---|
| Steel | Chemical composition(mass %) Balance: Fe and impurities | | | | | | | | | | Metal dust |
| No | W | V | Zr | Nb | Hf | B | Ca | Mg | REM | Weldability | resistance |
| 21 | — | — | — | — | — | 0.0038 | — | — | — | ◯ | Δ |
| 22 | — | — | — | — | — | — | 0.0020 | — | — | ◯ | ⊚ |
| 23 | — | — | — | — | — | 0.0037 | 0.0018 | — | — | ◯ | ◯ |
| 24 | — | — | — | — | — | — | — | — | 0.021 | ◯ | ⊚ |
| 25 | — | — | — | — | — | — | — | — | 0.043 | ◯ | Δ |
| 26 | — | — | — | — | — | 0.0044 | 0.0030 | — | 0.041 | ◯ | ⊚ |
| 27 | — | — | — | — | — | 0.0036 | 0.0016 | — | 0.018 | ◯ | ⊚ |
| 28 | — | — | — | — | — | 0.0039 | 0.0009 | — | — | ◯ | Δ |
| 29 | — | — | — | — | — | 0.0036 | 0.0021 | — | — | X | X |
| 30 | — | — | — | — | — | 0.0032 | 0.0016 | — | — | ◯ | ◯ |
| 31 | — | — | — | — | — | 0.0038 | 0.0022 | — | — | ◯ | ⊚ |
| 32 | — | — | — | — | — | 0.0037 | 0.0018 | — | — | ◯ | Δ |
| 33 | — | — | — | — | — | 0.0031 | — | — | — | ◯ | X |
| 34 | — | — | — | — | — | 0.0036 | 0.0021 | — | — | X | Δ |
| 35 | — | — | — | — | — | 0.0024 | 0.0024 | — | — | ◯ | ◯ |
| 36 | — | — | — | — | — | 0.0021 | 0.0031 | — | — | ◯ | Δ |

—: The content is an impurity level.
*The chemical composition is out of the range limited by the present invention.

In “weldability” of evaluation shown in Tables 1 and 2, “x” means any crack generated in a bead except both the ends, “∘” means no crack in a bead at all. Also, “x” in “metal dust resistance” means generation of pit in less than 200 hours, “Δ” means generation of pit from 200 hours or more to less than 500 hours, “∘” means generation of pit from 500 hours or more to less than 1000 hours, and “ [symbol] ” means no generation of pit in 1000 hours.

As shown in Tables 1 and 2, in Nos. 1 to 6 where the content of Ti is below the range specified by the present invention, the generation of the weld solidification cracking occurred over the entire length of weld bead, and the weldability was poor. No. 29 where the content of Ti is above the range specified by the present invention, was not only bad in the metal dusting resistance, but also a lot of solidification cracks occurred in forging, and the weldability was very poor. In No. 7 where the content of Ti is within the range specified by the present invention, but no Cu is contained, there was no generation of the weld solidification cracking though, a sufficient metal dusting resistance was not able to be maintained.

In No. 33 where the content of Ti is within the range specified by the present invention, but the content of Si and Cu each is outside of the range specified by the present invention, the sufficient metal dusting resistance was not be able to be maintained. Also, No. 34 where the content of Ti is within the range specified by the present invention, but the content of Al is beyond the range specified by the present invention, the metal dusting resistance was able be maintained, but a lot of cracks occurred in the heat affected zone by welding.

In contrast, in Nos. 8-28 and 30-32, 35, 36 satisfying all conditions specified by the present invention, there was no weld solidification cracking in the weld bead by the constraint weld cracking test, the weld solidification cracking susceptibility was extremely reduced, and also the metal dusting resistance was excellent.

### INDUSTRIAL APPLICABILITY

The weld joint of the present invention is excellent in the metal dusting resistance and the weldability, so that it can be utilized in tubes of heating furnace, pipes, or tubes of heat exchanger in the petroleum refinery and the petroleum chemistry plant, it can greatly improve the weld workability, the durability and the safety of apparatus.

Although only some exemplary embodiments of this invention have been described in detail above, those skilled in the art will readily appreciated that many modifications are possible in the exemplary embodiments without materially departing from the novel teachings and advantages of this invention. Accordingly, all such modifications are intended to be included within the scope of this invention.

1. A weld joint comprising a base material and a weld metal both having a chemical composition including C: 0.01-0.45%, Si: more than 1%, 4% or less, Mn: 0.01-2%, P: 0.05% or less, S: 0.01% or less, Cr: 15-35%, Ni: 40-78%, Al: 0.005-2%, N: 0.001-0.2% and Cu: 0.015-5.5% in mass percent, further including Ti satisfying the following formula (1), and the balance being Fe and impurities:
{(Si-0.01)/30}+0.01Cu≦Ti≦5 (1)
wherein a symbol of an element in formula (1) means a content of the element (mass percent).

2. The weld joint according to claim 1, wherein both the base material and the weld metal have a chemical composition including at least one kind selected from Co: 0.015-5.5%, Mo: 0.05-10%, Ta: 0.05%-5%, W: 0.05-5%, V: 0.01-1%. Zr: 0.01-1.4%, Nb: 0.01-1.4% and Hf: 0.01-1% in mass percent in place of a part of Fe.

3. The weld joint according to claim 1 , wherein both the base material and the weld metal have a chemical composition including at least one kind selected from B: 0.0005-0.3%, Ca: 0.0005-0.02% and Mg: 0.0005-0.02% in mass percent in place of the part of Fe.

4. The weld joint according to claim 1, wherein both the base material and the weld metal have a chemical composition including REM: 0.005-0.3% in mass percent in place of the part of Fe.

5. A weld material to produce a weld joint comprising a base material and the weld material, the weld material having a chemical composition including C: 0.01-0.45%, Si: more than 1%, 4% or less, Mn: 0.01-2%, P: 0.05% or less, S: 0.01% or less, Cr: 15-35%, Ni: 40-78%, Al: 0.005-2%, N: 0.001-0.2% and Cu: 0.015-5.5% in mass percent, further including Ti satisfying the following formula (1), and the balance being Fe and impurities:
{(Si-0.01)/30}+0.01Cu≦Ti≦5 (1)
wherein the symbol of the element in formula (1) means the content of the element (mass percent).

6. The weld material according to claim 5 having a chemical composition including at least one kind selected from Co: 0.015-5.5%, Mo: 0.05-10%, Ta: 0.05-5%, W: 0.05-5%, V: 0.01-1%. Zr: 0.01-1.4%, Nb: 0.01-1.4% and Hf: 0.01-1% in mass percent in place of the part of Fe.

7. The weld material according to claim 5 having a chemical composition including at least one kind selected from B: 0.0005-0.3%, Ca: 0.0005-0.02% and Mg: 0.0005-0.02% in mass percent in place of the part of Fe.

8. The weld material according to claim 5, having a chemical composition including REM: 0.005-0.3% in mass percent in place of the part of Fe.

9. The weld joint according to claim 2, wherein both the base material and the weld metal have a chemical composition including at least one kind selected from B: 0.0005-0.3%, Ca: 0.0005-0.02% and Mg: 0.0005-0.02% in mass percent in place of the part of Fe.

10. The weld joint according to claim 2, wherein both the base material and the weld metal have a chemical composition including REM: 0.005-0.3% in mass percent in place of the part of Fe.

11. The weld joint according to claim 3, wherein both the base material and the weld metal have a chemical composition including REM: 0.005-0.3% in mass percent in place of the part of Fe.

12. The weld material according to claim 6, having a chemical composition including at least one kind selected from B: 0.0005-0.3%, Ca: 0.0005-0.02% and Mg: 0.0005-0.02% in mass percent in place of the part of Fe.

13. The weld material according to claim 6, having a chemical composition including REM: 0.005-0.3% in mass percent in place of the part of Fe.

14. The weld material according to claim 7, having a chemical composition including REM: 0.005-0.3% in mass percent in place of the part of Fe.
